(19) United States
(12) Patent Application Publication
(10) Pub. No.: US 2014/0285565 A1
(43) Pub. Date: Sep. 25, 2014

(54) INKJET PRINTING APPARATUS AND PRINTING METHOD

(71) Applicant: Yuan Chang, Newtown Square, PA (US)

(72) Inventor: Yuan Chang, Newtown Square, PA (US)

(21) Appl. No.: 14/353,031

(22) PCT Filed: May 10, 2012
(86) PCT No.: PCT/CN2012/075272

§ 371 Date: Apr. 21, 2014

(51) Int. Cl. B41J 13/00

(52) U.S. Cl. CPC B41J 13/0009
USPC 347/16

(57) ABSTRACT

The present invention provides an inkjet printing apparatus, including a conveyer system to place and transmit print substrates, a printing module with at least one print head installed to eject ink droplets on the print substrates and the control system to control the movement of print head and conveyer system, wherein the conveyer system has an integrated design with no less than two stations to conduct different processing operations of the print substrates. By adopting the integrated design of multi-stations on the conveyer system, the structure of the inkjet printing apparatus in the present invention becomes more compact, its size becomes smaller and the costs are lowered. At the same time, the simultaneous and semi-automatic operation for loading, printing and collection is realized and thus inkjet printing efficiency enhanced. This integrated design of multi-stations also secures the safety of loading and collection by controlling the printing module to move in the range of the printing station.

### FIELD OF THE INVENTION

This invention relates to an inkjet printing apparatus, and relates more particularly to the inkjet printing apparatus of integrated design with multi-stations and semi-automatic printing apparatus and printing method.

### BACKGROUND OF THE INVENTION

Inkjet printer prints image and characters on the print substrate by eject ink droplets out of the print head. It has widely adopted in advertising production, office stationery printing and printing proofing due to its fast printing speed, bright image colors, long image preservation and low pollution. Usually, the printer consists of the printing module and the conveyer system. The printing module is to print images and characters and controls the print head, while the conveyer system is where the print substrate is loaded. Generally, the small size printer in prior art assembles the two parts together and the Y axis moves towards each single module to print. Under this mode, loading, printing and collection need to be done one step after another and this is time-consuming and low efficient. However, on large size printer for industrial use, the printing module and the conveyer system are installed separately, which means that the conveyer system transmit the print substrates separately. In such case, the printer structure is complicated, its size enlarged, operation more difficult and operation safety cannot be secured. Taking the two modes into consideration, an inkjet printing apparatus with modularized design, automatic and convenient operation, and small size is required to meet industrial and market demand. It can lower design costs, increase printing efficiency and guarantee a printing system that is safer, more convenient and more simplified in operation.

### SUMMARY OF THE INVENTION

In view of the problems in prior art, the purpose of the present invention is to provide with a printing apparatus of integrated design with multi-stations and semi-automatic printing and of simple structure, small size and high efficiency.

To realize the purpose, the present invention presents an inkjet printing apparatus, including a conveyer system for placing and convey the print substrates, a printing module with at least one print head to eject ink droplets on the print substrates and a control system to control the print head and conveyer system movement, wherein the conveyer system of integrated design has no less than two stations to conduct different processing operations of the print substrates.

The inkjet printing apparatus, wherein the conveyer system is a conveyor belt driven by the motor and moving along the Y axis direction;

The inkjet printing apparatus, wherein the conveyor belt has a loading station and a printing station, the loading station is at the entrance end of the apparatus and is used to place the print substrates, the printing station is where the print substrates will be printed.

The inkjet printing apparatus, wherein the conveyor belt also has a collection station that is at the exit end of the inkjet printing apparatus and is used to collect the print substrates that have been printed.

The inkjet printing apparatus, wherein the loading station, the printing station and the collection station can be manually switched from one to another; when switch, the motor controlled by the control system drives the conveyor belt to move from printing station to collection station.

The inkjet printing apparatus, wherein the printing module can move along the Y axis direction and it moves in the distance range of the printing station in the Y axis direction.

The inkjet printing apparatus, wherein the printing module is dragged by the cable carrier and slides in the Y axis direction with the guide rail slides; the slides are mounted beneath the printing module and the guide rail is installed on the base of the conveyer system.

An inkjet printing method, wherein its steps include:
a) Place the print substrates on the loading station before printing;
b) Operator press the start button to move the print substrates to the next station, then the print substrates will be moved to the printing station and the inkjet printing apparatus will start to print, at the same time, the operator can load new print substrates on the loading station for the next round of printing;
c) After printing, the operator pressed the start button again to move the print substrates that have been printed to the next station, the print substrates loaded for print will be moved to the printing station and the print substrates that have been printed will be moved to the container or the collection station where the operator will collected the print substrates that have been printed, in this way, a continuous printing process is realized.

In step b), the printing module move toward the direction opposite to the loading station.

Compared to the invention in prior art, the achievements of the present invention are:
1. The multi-station in the present invention can realize a simultaneous operation of loading, printing and collection, which reduces the printing time, lowers labor cost and improves printing efficiency.
2. The conveyer system in the present invention is an integrated design that has simplified the printer structure reduced printer size and increased the operation controllability.
3. Manually controlled buttons are installed on the conveyer system in the present invention. Operators can start or stop the transmission by pressing the buttons according to their own situation, which has increased the operation safety and reliability.
4. Guide rail slides are applied to the printing module in the present invention to guarantee that the guide rail beam moves in the range of the printing station and also to assure operation safety of loading and collection.

### BRIEF DESCRIPTION OF THE DRAWINGS

FIG. 1 is a perspective view of the inkjet printing apparatus of one embodiment in the present invention;

FIG. 2 is a side view of FIG. 1;

FIG. 3 is a perspective view of the printing module (without its outer cover) in FIG. 1;

FIG. 4 is a perspective view of the conveyer system in FIG. 1;

FIG. 5 is a perspective view of the conveyer system of the inkjet printing apparatus in another embodiment of the present invention.

### DETAILED DESCRIPTION OF THE EMBODIMENT

Preferred embodiments of an inkjet printing apparatus and printing method according to the present invention is described but not confined below with reference to the accompanying figures.

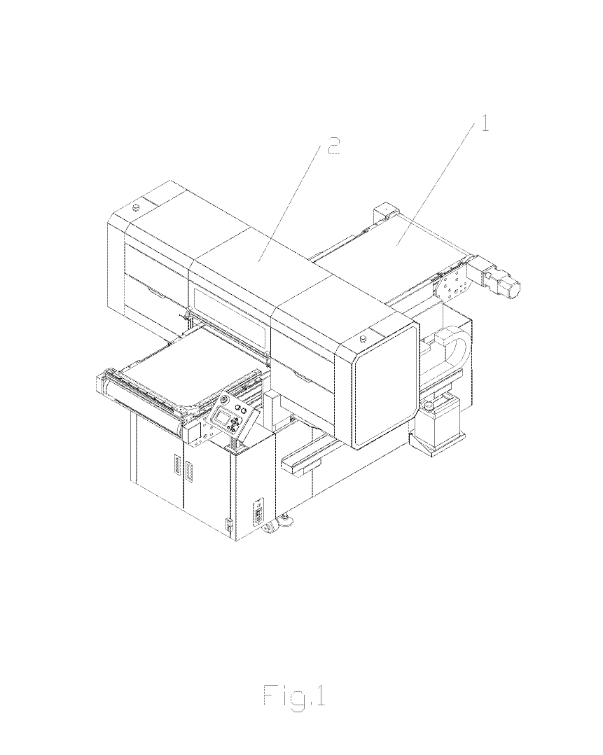

As shown in FIG. 1, the inkjet printing apparatus in the present embodiment includes a conveyer system 1, a printing module 2 and a control system (not shown in FIG. 1) to control the printing process. The control system controls the movement of the printing module 2 and print heads to eject ink droplets in the printing station on the printing substrates to form images or characters. The control system also has a manual button to control the movement of the conveyer system.

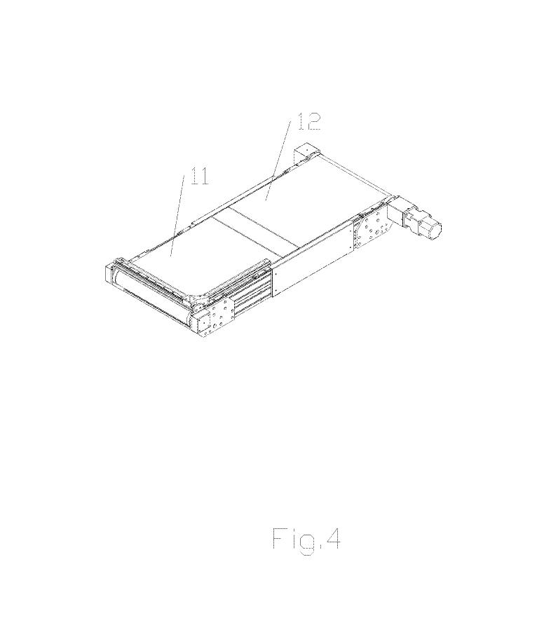

As shown in FIG. 4, the conveyer system in the present embodiment is an integrated conveyor belt with a loading station 11 to load print substrates to be printed and printing station 12 to print the print substrates. The control system controls the conveyer system 1 to move along the Y axis in which direction the length of the loading station and printing station is the same. Each time the conveyer belt moves, it moves from one station to another.

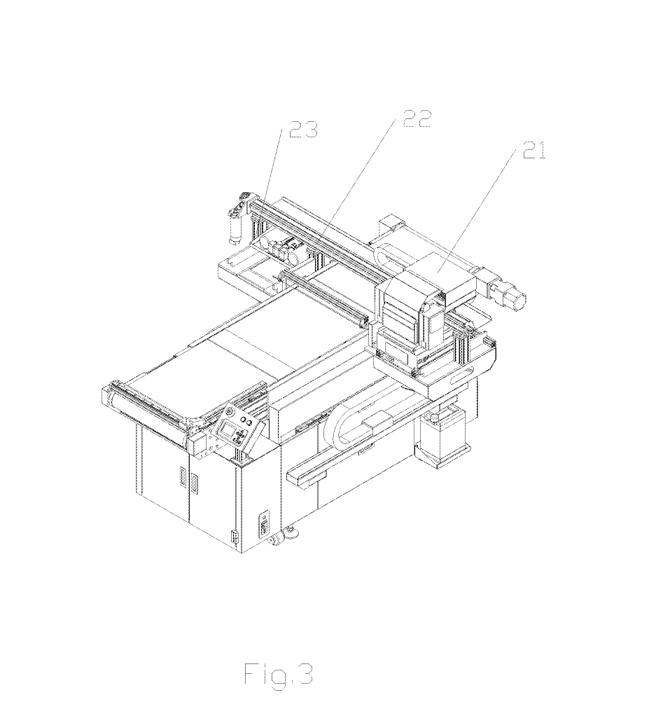

As shown in FIG. 3, the printing module mainly consists of the carriage 21 and the guide rail beam 22, among which the carriage 21 is installed on and moves to and fro along the guide rail beam 22 under the control of the control system, and the guide rail beam 22 is installed on the supporting shelf 23 which is connected to the printer base through the guide rail slides. When printing, the print substrates don't move, while the control system control the printing module 2 to move along the Y axis direction and towards the direction opposite to the loading station 11, the carriage 21 to move back and forth along the X axis direction and print heads to eject ink droplets on the print substrate to form image or character. The guide rail slides controls the guide rail beam 22 to move in the range of the printing station 12 in Y axis direction.

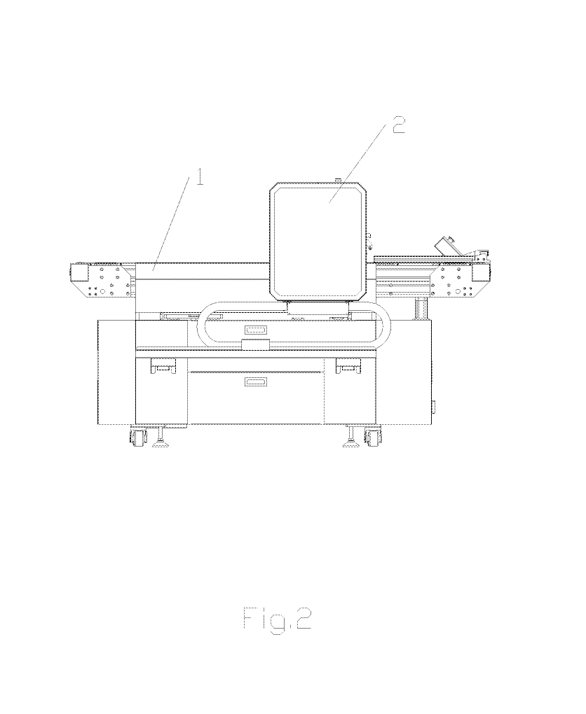

Detailed operation procedure of the inkjet printing apparatus in the present invention is described according to FIG. 1-FIG. 3.

Operator place the print substrates on the loading station 11 and then press the button to start up the control system. The control system control the conveyor belt to move one station forward, i.e, from the loading station 11 to the printing station 12. Then the conveyor belt stops moving and the carriage 21 of the printing module 2 begin to print image or character on the print substrates. When printing, the carriage 21 move to and fro along the guide rail beam 22 or X axis to print under the control of the control system. At the same time, the control system control the printing module 2 to move towards the direction opposite to the loading station 11 in Y axis direction and stop moving until the carriage 21 move to the final printing station 12 and finish printing the preset images or characters on the print substrates. During printing, operators can place new print substrates on the loading station 11. After finishing the printing, operator can press the button again to move the conveyor belt forward to the next station and then the print substrates that have been printed will slides into the container, at the same time, the newly placed print substrates will be moved to the printing station 12 for the next round of print. In this way, semi-automatic loading and printing of the inkjet printing are realized simultaneously and continuously, thus inkjet print efficiency is improved.

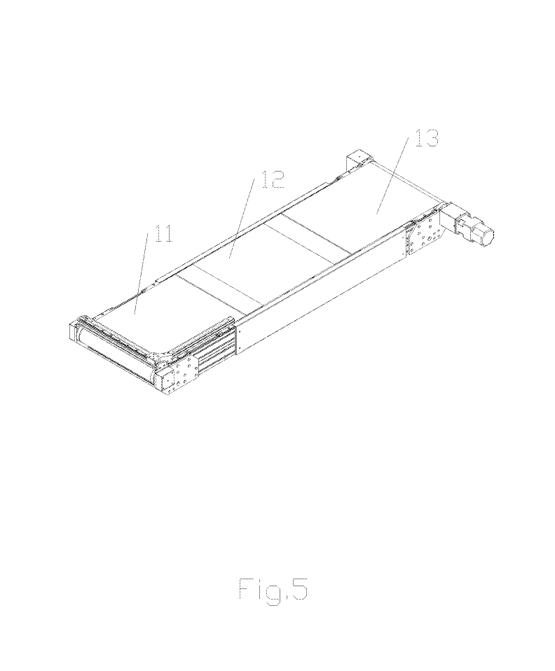

This embodiment of the present invention provides a semi-automatic inkjet printing apparatus with three stations, as shown in FIG. 5. The conveyer system 1 in this embodiment adopts an integrated conveyor belt with three stations: loading station 11, printing station 12 and collection station 13. Loading station 11 is where the print substrates are placed; the printing station is where the print substrates will be printed; the collection station 13 is where operators collect the print substrates that have been printed. The control system controls the conveyer system to move along Y axis and the conveyer system move from one station to another each time. In Y axis, the length of the three stations is the same.

When to print, operators load the print substrates on the loading station and then press the start button to start up the control system. The control system move the conveyor belt to the next station, i.e. from the loading station 11 to the printing station 12. Then the conveyor belt stop moving and the carriage 21 of the printing module 2 begin to print on the print substrates. During printing, the control system controls the carriage 21 to move to and fro along the guide rail beam 22 or X axis. At the same time, the control system controls the guide rail beam 12 to move towards the direction opposite to the loading station 11 in Y axis and stop moving until the carriage move to the final station and finish printing the preset image or character on the print substrates. During printing, operators can place new print substrates on the loading station 11. After finishing printing, operators can press the button again to move the conveyor belt one station forward and then the print substrates that have been printed will move from the printing station 12 to the collection station 13 and put away by the operators. At the same time, new print substrates will be moved to the printing station 12 for the next round of printing. In this way, semi-automatic loading and printing of the inkjet printing are realized simultaneously and continuously, thus inkjet print efficiency is improved.

During the printing process in the present invention, the guide rail beam 22 moves along the Y axis under the control of guide rail slides 24. It will not move beyond the range of the printing station 12, thus safety of loading and collection operation is guaranteed.

The integrated design of the multi-station on the conveyer system of the inkjet printing apparatus in the present invention make the apparatus more compact in structure, smaller in size and lower in cost. This design has improved the inkjet printing efficiency through the simultaneous and automatic operation of loading, printing and collection. It has also assured the safety of loading and collection by confining the printing module movement in the range of printing station 12.

What claimed is:

1. An inkjet printing apparatus includes,
a) Conveyer system, to place and convey the print substrates;
b) Printing module, including at least one print head to eject ink droplets on the print substrates;
c) Control system to control the movement of the print head and the conveyer system;
Wherein, the integrated design of the conveyer system has no less than two work stations to conduct different processing operations of the print substrates.

2. The inkjet printing apparatus of claim 1, wherein the conveyer system is a conveyor belt which is driven by the motor and move in Y axis direction.

3. The inkjet printing apparatus of claim 2, wherein the conveyor belt includes loading station and printing station, among which the loading station is on the entrance end of the apparatus and the printing station is where the print substrates will be printed.

4. The inkjet printing apparatus of claim 3, wherein the conveyor belt also includes collection station which is on the exit end of the apparatus to collect the print substrates that have been printed.

5. The inkjet printing apparatus of claim 4, wherein, the moving distance of the loading station, printing station and collection station are the same in Y axis direction.

6. The inkjet printing apparatus of claim 1, wherein the loading station, printing station and collection station can be manually switched from one to another; when switch, the motor controlled by the control system drives the conveyor belt to move from printing station to collection station.

7. The inkjet printing apparatus of claim 1, wherein the printing module can move along the Y axis direction and it moves in the distance range of the printing station in Y axis direction.

8. The inkjet printing apparatus of claim 7, wherein the printing module is dragged by the cable carrier and slides in the Y axis direction with the guide rail slides; the slides are mounted beneath the printing module and the guide rail is installed on the base of the conveyer system.

9. A printing method of the inkjet printing apparatus of claim 1, wherein its printing procedure is as follows:
a) Place the print substrates on the loading station before printing;
b) Operator press the start button to move the print substrates to the next station, then the print substrates will move to the printing station and the inkjet printing apparatus began to print, at the same time, the operator can load new print substrates for another round of printing;
c) After printing, operator press the start button again to move the print substrates to the next station; at this time, the print substrates loaded for print will be moved to the printing station and the print substrates that have been printed will be moved to the container or the collection station, the operator will collect the print substrates that have been printed, in this way, a continuous printing process is realized.

10. The printing method of claim 9, wherein when printing in step 12), the printing module move toward the direction opposite to the loading station.
